(19) United States
(12) Patent Application Publication
(10) Pub. No.: US 2009/0258295 A1
(43) Pub. Date: Oct. 15, 2009

(54) ELECTROCHEMICAL ENERGY SOURCE, AND METHOD FOR MANUFACTURING SUCH AN ELECTROCHEMICAL ENERGY SOURCE

(75) Inventors: Rogier Adrianus Henrica Niessen, Eindhoven (NL); Petrus Henricus Laurentius Notten, Eindhoven (NL); Remco Henricus Wilhelmus Pijnenburg, Leuven (BE); Johannes Hubertus Gerardus Op Het Veld, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS N.V., EINDHOVEN (NL)

(21) Appl. No.: 12/375,061

(22) PCT Filed: Jul. 25, 2007
(86) PCT No.: PCT/IB07/52956

§ 371 Date: Jan. 26, 2009

(30) Foreign Application Priority Data
Jul. 31, 2006 (EP) 06118151.7

(51) Int. Cl. H01M 4/00; H01M 4/82; H01M 4/58; H01M 4/34; H01M 4/42; H01M 4/56

(52) U.S. Cl. 429/219; 429/209; 29/623.5; 429/218.1; 429/231.1; 429/220; 429/229; 429/225; 429/231.6; 429/231.95

(57) ABSTRACT

The invention relates to an electrochemical energy source, comprising: a substrate, and at least one stack deposited onto said substrate, the stack comprising: an anode, a cathode, and an intermediate solid-state electrolyte separating said anode and said cathode; and at least one electron-conductive barrier layer being deposited between the substrate and the anode, which barrier layer is adapted to at least substantially preclude diffusion of active species of the stack into said substrate. The invention further relates to a method for manufacturing such an electrochemical energy source, comprising the steps of: A) depositing at least one electron-conductive barrier layer onto the substrate, and B) depositing at least one stack of an anode, an solid-state electrolyte, and a cathode successively onto said electron-conductive barrier layer.

The invention relates to an electrochemical energy source, comprising: a substrate, and at least one stack deposited onto said substrate, the stack comprising: an anode, a cathode, and an intermediate solid-state electrolyte separating said anode and said cathode; and at least one electron-conductive barrier layer being deposited between the substrate and the anode, which barrier layer is adapted to at least substantially preclude diffusion of active species of the stack into said substrate. The invention also relates to an electronic assembly comprising at least one electrochemical energy source according to the invention, wherein at least one electronic component is at least partially embedded in the substrate of the electrochemical energy source. The invention further relates to a method for manufacturing such an electrochemical energy source, comprising the steps of: A) depositing at least one electron-conductive barrier layer onto the substrate, and B) depositing at least one stack of an anode, an solid-state electrolyte, and a cathode onto said electron-conductive barrier layer.

Electrochemical energy sources based on solid-state electrolytes are known in the art. These (planar) energy sources, or ‘solid-state batteries’, efficiently convert chemical energy into electrical energy and can be used as the power sources for portable electronics. At small scale such batteries can be used to supply electrical energy to e.g. microelectronic modules, more particular to integrated circuits (IC's). An example hereof is disclosed in the international patent application WO2005/027245, where a solid-state thin-film micro battery, in particular a lithium ion micro battery, is fabricated directly onto a silicon substrate. The substrate may comprises one or more electronic components to form a so-called system-on-chip. During the fabrication process of this system-on-chip, an electron-conductive barrier layer, and a stack of an anode, a solid-state electrolyte, and a cathode are deposited successively on the silicon substrate. The barrier layer is adapted to counteract diffusion of intercalating lithium ions into said substrate, which diffusion would result in a significant diminished storage capacity of the electrochemical source. Although the known micro battery exhibits commonly superior performance as compared to other solid-state batteries, the known micro battery has several drawbacks. It has been found that a major drawback of the known micro battery is that minute quantities of lithium can penetrate this diffusion barrier over a long period of time and will still enter the silicon substrate, which will commonly seriously affect the performance of electronic components, like for example Metal Oxide Semiconductor Field Effect Transistors (MOSFETs), already embedded in the substrate. Moreover, the storage capacity of the electrochemical energy source will also be affected by this reduction of effective lithium ions contained by the stack.

It is an object of the invention to provide an electrochemical energy source having an improved long-term performance.

This object can be achieved by providing an electrochemical energy source according to the preamble, characterized in that the electrochemical energy source further comprises at least one getter layer being deposited between the substrate and the barrier layer for gettering active species which have been diffused through the barrier layer. Since the getter layer selectively binds, commonly by means of chemical bonding, active species that have somehow managed to pass the barrier layer, entering of active species into the underlying substrate can be prevented, as a result of electronic components which may be embedded in the substrate will no longer be affected by active species initially contained by the stack. An additional advantage is of the application of the at least one getter layer is that the performance of the electrochemical energy source, and in particularly of the stack, can be maintained at least substantially both in short-term and in long-term. Selective gettering and subsequent retaining of active species is achieved by the fact that the (chemical) bonding of the active species by the getter material is energetically more favorable than the bonding of the active species by the substrate. In other words; the bonding product, commonly being a (chemical) reaction product, formed by the getter material and an active species is thermodynamically (substantially) more stable than the bonding product formed by the substrate and said active species.

Gettering of the active species, which active species are often formed by metal atoms (e.g. lithium atoms, magnesium atoms, or copper atoms), can be realized in different manners. In a preferred embodiment the at least one getter layer comprises at least one metal. More preferably, the getter layer is substantially made of metal. In this case the getter material will commonly form a stable alloy with the active species. In a particular preferred embodiment the getter layer comprises at least one of the following metals: Antimony (Sb), Bismuth (Bi), Tin (Sn), Gallium (Ga), Cadmium (Cd), Lead (Pb) and Indium (In). From this group, in particular antimony and bismuth are considered to be significant advantageously, since it has been found that a bonding between an active species and antimony or bismuth is substantially more stable than the bonding between the active species between an active species and the substrate, in particular in case the active species are formed by lithium ions and the substrate is substantially made of silicon.

In an alternative preferred embodiment the at least one getter layer comprises at least one oxide. Suitable oxide-based getter materials, which forms a relatively stable reaction product with the active specie, are at least SiO₂, GeO₂, Al₂O₃, and Zr₂O₅. These types of materials all reduce in the presence of any free lithium to lithium oxide, effectively by capturing the lithium. For SiO₂ this occurs according to:

2Li+½SiO₂→Li₂O+½Si ΔG⁰=−113 kJ/half mole of oxygen

Similar reactions can be written for other oxides like, for example, alumina and zirconium. This shows that lithium is present as Li₂O in the SiO₂ layer, so in its ionic form (Li⁺). Due to defects in the oxide-based getter layer, active species, such as lithium atoms, initially contained by the stack will commonly easily get charged. To prevent charged lithium species (or other charged active species) from entering the substrate, preferably a barrier layer for active species, more preferably an electron-conductive barrier layer, is deposited between the substrate and the oxide-based getter layer. More preferably, a layer is applied that is rather inert with respect to metallic lithium. Suitable metals to apply are Tantalum (Ta), Gold (Au), Silver (Ag), and Titanium (Ti). However, it is also conceivable to apply other materials like nitrides. Suitable non-metal materials are for example Tantalum Nitride (TaN) and Titanium Nitride (TiN).

To realize an improved (lithium) ion barrier to prevent (lithium) ions, or other charged (mobile) active species from entering the substrate, the electrochemical energy source preferably comprises means for generating an electric field across at least one getter layer, in particular the oxide-based getter layer. More preferably, the means for generating an electric field across the at least one getter layer is connected to both electron-conductive barrier layers enclosing the oxide-based getter later, wherein the lowest electric potential is applied to the (upper) electron-conductive barrier layer neighboring the stack. Subsequently, defects and vacancies will force the effective transport of Li⁺ through the SiO₂ layer back in the direction of the (upper) barrier layer under influence of the electrical field applied. Preferably, the oxide-based getter layer applied has a relatively poor electric conductance, and is more preferably formed by a dielectric layer, to prevent short-circuiting of both barrier layers and to allow a reliable and durable electrical field across the getting layer. The absolute potential of the upper barrier layer will commonly be equal to the potential of the anode (commonly ˜0.2-0.6 Volt vs. Li/Li+). The lower or bottom barrier layer is preferably connected to the cathode of the stack. This results in the fact that the lower electron-conductive layer, which may be a barrier layer, commonly has a potential of around 4 Volt in the case the cathode consists of LiCoO₂ (commonly used). The forced transport of lithium ions towards the upper barrier layer might result in the neutralization of lithium ions to lithium atoms, which atoms may relatively easily be incorporated in the upper barrier layer. Aside from the fact that it is extremely facile to apply a potential difference across the lower barrier layer and the upper barrier layer, this manner of blocking (lithium) ions based on electromigration is energetically also relatively efficient. Energy is merely dissipated if neutralization of ions to atoms occurs as described afore. As the total amount of ions in the oxide-based getter layer will commonly be extremely low merely an infinitesimal amount of energy is required.

At room temperature the getter layer will commonly substantially not diffuse into the substrate. However, at higher temperature (possible needed during the manufacturing process of fully integrated thin-film batteries) inter-diffusion might occur. Therefore, preferably, an additional barrier layer is positioned between the substrate and the at least one getter layer which additional barrier layer prevents this inter-diffusion.

In general, the barrier layer is preferably at least substantially made of at least one of the following compounds: tantalum (Ta), tantalum nitride (TaN), and titanium nitride (TiN). These compounds have as common property a relatively dense structure which is permeable for electrons and impermeable for the intercalating species, among which lithium (ions). The material of the barrier layer is however not limited to these compounds. In case a metal-based getter layer is applied, the material of the additional barrier layer does commonly not need to be electronically conducting. To this end other materials, like Si₃N₄, may also be used. Si₃N₄ is a known to be an effective lithium barrier.

As described above both a metal-based getter layer and an oxide-based getter layer can be applied respectively. In a preferred embodiment the electrochemical energy source comprises a laminate of multiple getter layers being deposited between the substrate and the barrier layer. The getter layers are preferably positioned on top of each other according to the embodiment. The laminate may comprise alternating getter layers of one or more metal-based getter layers and one or more oxide-based getter layers. In this manner the gettering properties of the electrochemical energy source can be optimized. In this context it is also noted that forcing charged active species to a desired direction by means of electromigration as mentioned above is also possible in case a laminate of getter layers is applied. In case, for example a (MOMOM-) stack of a first metal-based getter layer (M), a first oxygen-based getter layer (O), a second metal-based getter layer (M), a second oxygen-based getter layer (O), and a third metal-based getter layer (M) are applied, the highest potential can be applied to the first metal-based getter layer, and the lowest potential can be applied to the third metal-based getter layer, while the intermediate second metal-based getter layer can be provided with an intermediate potential (which is between the highest potential en the lowest potential). The intermediate potential can e.g. be provided by means of one or multiple electronic components at least partially embedded in the substrate.

The solid-state electrolyte applied in the energy source of the energy system according to the invention may be based either on ionic conducting mechanisms and non-electronic conducting mechanisms, e.g. ionic conductors for H, Li, Be, Cu, Ag, and Mg. An example of a Li conductor as solid-state electrolyte is Lithium Phosphorus Oxynitride (LiPON). Other known solid-state electrolytes like e.g. Lithium Niobate (LiNbO₃), Lithium Tantalate (LiTaO₃), Lithium orthotungstate (Li₂WO₄), Lithium Germanium Oxynitride (LiGeON), Li₅La₃Ta₂O₁₂ (Garnet-type class), Li₁₄ZnGe₄O₁₆ (lisicon), Li₃N, beta-aluminas, or Li_{1.3}Ti_{1.7}Al_{0.3}(PO₄)₃ (nasicon-type) may also be used as lithium conducting solid-state electrolyte. A proton conducting electrolyte may for example be formed by TiO(OH), or ZrO₂Hₓ. Detailed information on proton conducting electrolytes is disclosed in the international application WO 02/42831. The positive electrode for a lithium ion based energy source may be manufactured of metal-oxide based materials, e.g. LiCoO₂, LiNiO₂, LiMnO₂ or a combination of these such as. e.g. Li(NiCoMn)O₂. Examples of a second (positive) electrode in case of a proton based energy source are Ni(OH)₂ and NiM(OH)₂, wherein M is formed by one or more elements selected from the group of e.g. Cd, Co, or Bi.

In a preferred embodiment at least one electrode comprises at least one of the following materials: C, Sn, Ge, Pb, Zn, Bi, Sb, and, preferably doped, Si. A combination of these materials may also be used to form the electrode(s). Preferably, n-type or p-type doped Si is used as electrode, or a doped Si-related compound, like SiGe or SiGeC. Also other suitable materials may be applied as electrode, preferably any other suitable element which is assigned to one of groups 12-16 of the periodic table, provided that the material of the electrode is adapted for intercalation and storing of reactive species such as e.g. of those elements as mentioned in the previous paragraph. Moreover, these materials are preferably suitable to undergo an etching process to apply a pattern (holes, trenches, pillars, etc.) on the contact surface of the substrate to increase the contact surface per volume between both electrodes and the solid-state electrolyte. Commonly, this increase of the contact surface(s) between the components of the energy source according to the invention leads to an improved rate capacity of the energy source, and hence a better battery capacity (due to an optimal utilization of the volume of the layers of the energy source). In this way the power density and energy density in the energy source may be maximized and thus optimized. The nature, shape, and dimensioning of the pattern may be arbitrary.

The stack preferably further comprises separate current collectors being electrically connected to the first electrode and the second electrode respectively. It is generally known to apply current collectors as electrode terminals. In case e.g. a Li-ion battery with a LiCoO₂ electrode is applied, preferably an aluminum current collector is connected to the LiCoO₂ electrode. Alternatively or in addition a current collector manufactured of, preferably doped, semiconductor such as e.g. Si, GaAs, InP, as of a metal such as copper, platinum, aluminum, gold or nickel may be applied as current collector in general with solid-state energy sources according to the invention. More preferably, at least a part of each current collector is left uncovered by the protective packaging in order to enable a facilitated connection of the energy source according to the invention with an electronic module or device. Other parts of the outer surface of the stack (besides a part of the current collectors) are preferably fully covered by the protective packaging in a substantially mediumtight manner. In a particular preferred embodiment at least one of the current collectors is formed by a conductive substrate onto which the adjacent electrode is deposited. The integration of the current collector and the first substrate supporting (among others) the energy source commonly leads to a relatively simple construction of the energy source according to the invention. Moreover, the way of manufacturing of the energy source is also simpler, as at least one process step can be eliminated. The relatively simple manufacturing method of the energy system according to the invention may furthermore lead to a significant cost saving. In a preferred embodiment the substrate(s) is/are made of at least one of the following materials: C, Si, Sn, Ti, Ge, Al, Cu, Ta, and Pb. A combination of these materials may also be used to form the substrate(s). Preferably, n-type or p-type doped Si is used as substrate, or a doped Si-related compound, like SiGe or SiGeC. Preferably, a substrate, in particularly a monocrystalline silicon conductive substrate, is applied in which one or multiple electronic components and/or devices, such as integrated circuits (ICs), chips, displays, et cetera, are embedded at least partially.

The invention also relates to an electronic assembly comprising at least one electrochemical energy source according to the invention, wherein at least one electronic component is at least partially embedded in the substrate of the electrochemical energy source. Examples of electronic components which may be embedded in the substrates have already been described above.

The invention further relates to a method according to the preamble, characterized in that the method further comprises step C) comprising depositing at least one getter layer onto said substrate before step A) is carried out, wherein the electron-conductive barrier layer is deposited onto said getter layer. In a preferred embodiment during step C) a laminate of multiple getter layers is deposited onto the substrate. At least one getter layer which is deposited during step C) comprises at least one oxide. Deposition of the individual layers of the energy source can be achieved by means of conventional deposition techniques such as, for example, chemical vapor deposition, physical vapor deposition, and wet chemical deposition, in particular sol-gel deposition. Advantages of the application of one or more getter layers have been elucidated above in a comprehensive manner.

In a preferred embodiment the method further comprises step D) comprising the application of an electrical field across the getter layer, in particular across an oxide-based getter layer, deposited during step C). Preferably, the method further comprises step E) comprising depositing at least one electron-conductive barrier layer onto said substrate before steps A)-D) are carried out. The barrier layer is substantially impermeable for active species. In a particular preferred embodiment an electrical potential is applied to both electron-conductive barrier layers to generate an electrical field across the getter layer, wherein the lowest electrical potential is applied to the electron-conductive barrier layer neighboring the stack. In this manner positive charged ions contained by the getter layer can efficiently be forced back into the barrier layer neighboring the stack. Further advantages and alternative embodiments of the method according to the invention have already been described above. In this context it is noted that is not necessary to deposit the cathode after depositing the anode and the electrolyte successively; in contrary, it would also be conceivable that the cathode is deposited prior to the deposition of the anode, wherein the anode will be connected separately to the substrate after depositing. Therefore, both a regular stack (anode directed to the substrate) and a reverse stack (cathode directed to the substrate) can be incorporated in the electrochemical energy source according to the invention.

The invention is illustrated by way of the following non-limitative examples, wherein:

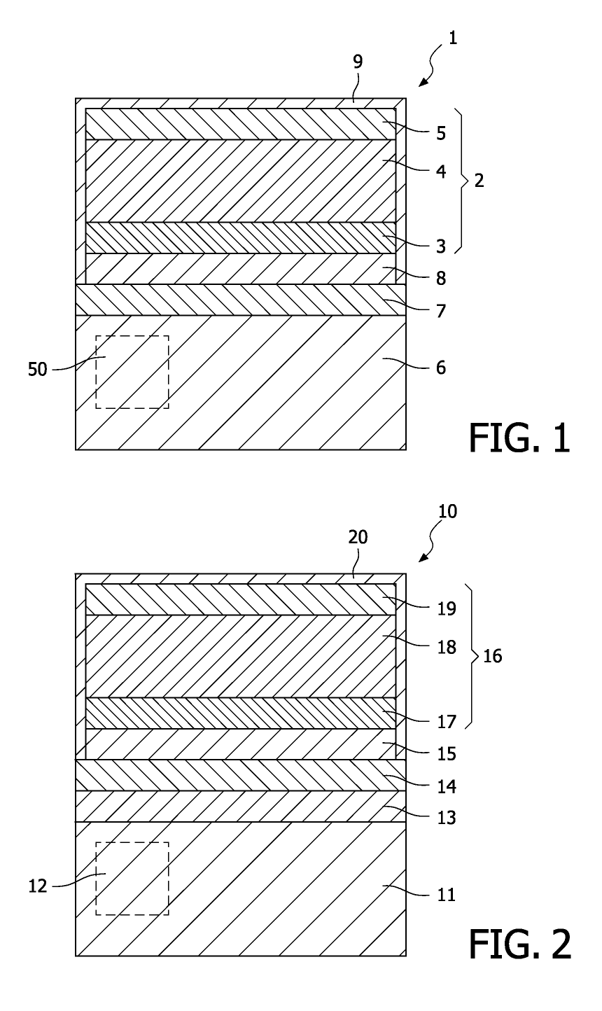

FIG. 1 shows a cross section of a first embodiment of an electrochemical energy source according to the invention,

FIG. 2 shows a cross section of a second embodiment of an electrochemical energy source according to the invention,

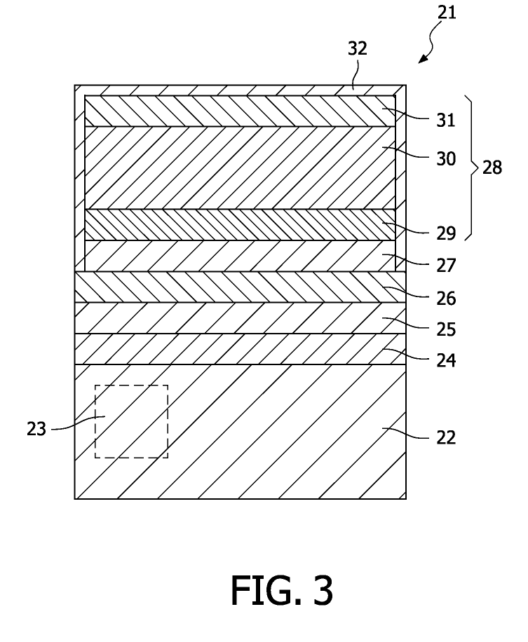

FIG. 3 shows a cross section of a third embodiment of an electrochemical energy source according to the invention,

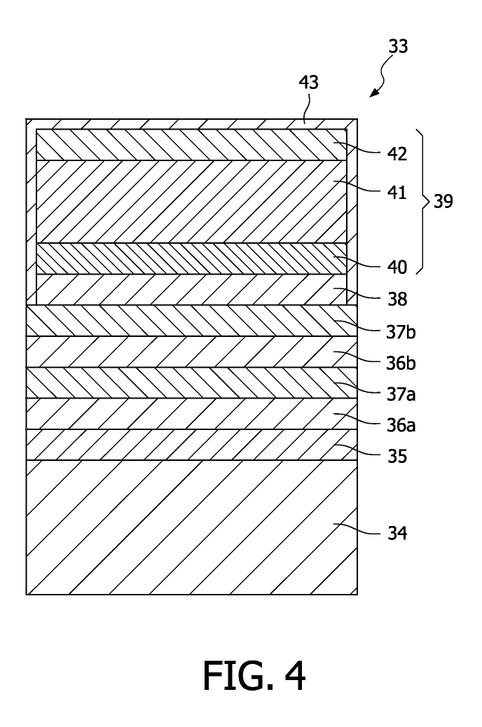

FIG. 4 shows a cross section of a fourth embodiment of an electrochemical energy source according to the invention,

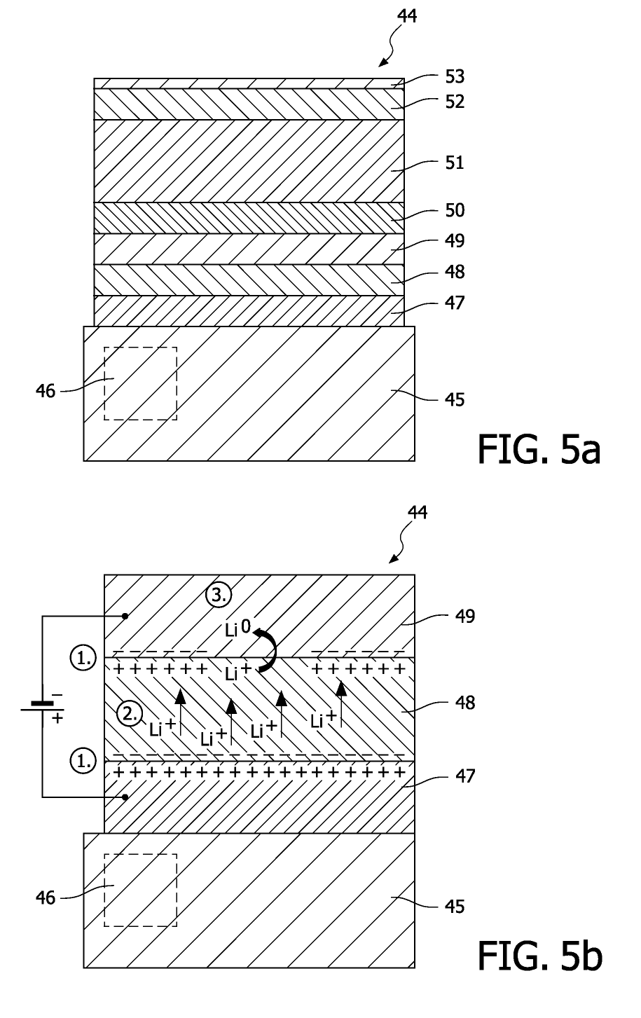

FIG. 5a shows a cross section of a fifth embodiment of an electrochemical energy source according to the invention, and

FIG. 5b shows a detailed view of a part of the cross section of the energy source as shown in FIG. 5a.

FIG. 1 shows a cross section of a first embodiment of an electrochemical energy source 1 according to the invention. The energy source 1 comprises a lithium ion battery stack 2 of an anode 3, a solid-state electrolyte 4, and a cathode 5, which battery stack 2 is deposited onto a conductive substrate 6 in which one or more electronic components 50 are embedded. In this example the substrate 6 is made of doped silicon, while the anode 3 is made of amorphous silicon (a-Si). The cathode 5 is preferably made of a metal-oxide, such as LiCoO₂, LiMnO₂, LiNiO₂, et cetera. Between the battery stack 2 and the substrate a getter layer 7 and a lithium barrier layer 8 are deposited successively onto the substrate 6. In this example, the getter layer 7 is substantially made of metal, preferably bismuth or antimony. The lithium diffusion barrier layer 8 is preferably made of tantalum. An outer surface of the battery stack 2 is covered by a protective packaging 9 acting as a seal. The packaging 9 is preferably formed by a laminate of a silica layer deposited onto the stack 2, and a tantalum layer deposited onto the silica layer. The conductive tantalum layer acts as a chemical barrier, since this layer is substantially impermeable for both lithium ions and atmospheric compounds. To prevent short-circuiting of the anode 3 and the cathode 5 the intermediate electrically insulating silica layer is applied. Deposition of the individual layers 3, 4, 5, 7, 8, 9 can be achieved, for example, by means of CVD, sputtering, E-beam deposition or sol-gel deposition. Diffusion of lithium ions (or other active species) initially contained by the stack 2 into the substrate 6 can be counteracted by means of the lithium ion barrier layer 8. In case lithium ions would leave the stack 2 and would enter the substrate 6 the performance of the stack 2 would be affected. Moreover, this diffusion would seriously affect the electronic component(s) 50 embedded within the substrate 6. The getter layer 7 is applied as additional precautionary measure. In case (minute) amounts of lithium would somehow manage to diffuse through the barrier layer 8, this free lithium will be gettered by the getter layer 7. In this manner deterioration of both the battery stack 2 and the substrate 6 including the electronic components 9 can be prevented. Thus, by applying both the laminate of the getter layer 7 and the lithium ion barrier layer 8 the performance of the electrochemical energy source 1 as a whole can be held substantially stable both in short-term and in long-term. Since, electronic components 50 may be present in the substrate, the expression electrochemical energy source 1 must be interpreted relatively broadly in this context. In case at least one electronic component is present in the substrate, the electrochemical energy source 1 may therefore also be considered as the electronic assembly according to the invention. The electrochemical energy source 1 (which may also be considered as an electronic assembly in this case) can furthermore be considered as an electrochemical assembly, a system-on-chip, and/or a system-in-package.

FIG. 2 shows a cross section of a second embodiment of an electrochemical energy source 10 according to the invention. The electrochemical energy source 10 comprises a silicon substrate 11 in which one or more electronic components 12, such as chips or so-called MOSFETs, are embedded. On top of the substrate 11 successively a lower lithium ion barrier layer 13, a getter layer 14, an upper lithium ion barrier layer 15, and a lithium ion based battery stack 16 are deposited. The battery stack 16 comprises an anode 17, an intermediate solid-state electrolyte 18, and a cathode 19. The upper barrier layer 15 and the battery stack 16 together are covered by a protective packaging 20. Both the lower barrier layer 13 and the upper barrier layer 15 are made of Ta, TaN, Ti, and/or TiN. The intermediate getter layer 14 enclosed by both barrier layers 13, 15 is made of bismuth or antimony. As will be clear the constructive structure of the electrochemical energy source 10 shown in FIG. 2 is more or less similar to the constructive structure of the electrochemical energy source 1 shown in FIG. 1, with the difference that an additional (lower) barrier layer 13 is applied. Application of this additional barrier layer 13 may be advantageous, since it often occurs that the getter layer 14 intends to diffuse with the underlying substrate 11, in particular at relatively high temperatures during the manufacturing process of the electrochemical energy source 10, as a result of which still some free lithium (or any other active species) initially contained by the battery stack 16 would be able enter the substrate. To prevent this inter-diffusion of the getter layer 14 and the substrate 11, both components 11, 14 are separated by means of the lower barrier layer 13. Aside from the fact that the barrier layer 13 separates the getter layer 14 from the substrate 11, the barrier layer 13 will also be impermeable for lithium ions which for some reason slipped through the upper barrier layer 15 and the getter layer 14, as a consequence of which measure the substrate 11 can be held free of lithium in a more reliable manner.

FIG. 3 shows a cross section of a third embodiment of an electrochemical energy source 21 according to the invention. The energy source 21 comprises a silicon substrate 22 in which one or more electronic components 23 are embedded. On top of the substrate 22 successively a bottom lithium ion barrier layer 24, a first getter layer 25, a second getter layer 26, a top lithium ion barrier layer 27, and a lithium ion based battery stack 28 are deposited. The battery stack 28 comprises conventionally an anode 29, an intermediate solid-state electrolyte 30, and a cathode 31. The top barrier layer 27 and the battery stack 28 together are covered by a protective packaging 32. Both the bottom barrier layer 24 and the top barrier layer 27 are made of Ta, TaN, and/or TiN. As shown in FIG. 3 the first getter layer 25 and the second getter layer 26 are positioned on top of each other as to form a bilayer getter. The first getter layer 25 is made of an oxide-based material, such as SiO₂, while the second getter layer 26 is made of a metal-based material, such as bismuth or antimony. Active species, such as free lithium, which have penetrated the top barrier layer 27 will at least substantially be gettered by one of the getter layers 25, 26. A lithium atom which is gettered by the first getter layer 25 will be fixed chemically in the first getter layer 25 by forming lithium oxide. Lithium atoms which are gettered by the second getter layer 26 will form an alloy with bismuth, antimony, and/or any other metal present in the second getter layer 26. As additional safeguard the bottom barrier layer 24 is applied to prevent diffusion of free lithium (somehow not being gettered by the getter layers 25, 26) into the substrate 22.

FIG. 4 shows a cross section of a fourth embodiment of an electrochemical energy source 33 according to the invention. The electrochemical energy source 33 shown in FIG. 4 is constructively more or less similar to the electrochemical source 21 shown in FIG. 3, and comprises a substrate 34 on top of which successively a bottom lithium ion barrier layer 35, a laminate of getter layers 36a, 36b, 37a, 37b, a top lithium ion barrier layer 38, and a lithium ion based battery stack 39 are deposited. The battery stack 39 comprises conventionally an anode 40, an intermediate solid-state electrolyte 41, and a cathode 42. The top barrier layer 38 and the battery stack 39 together are covered by a protective packaging 43. The laminate of getter layers 36a, 36b, 37a, 37b comprises metal-based getter layers 36a, 36b, and oxide-based getter layers 37a, 37b which are stack alternately on top of each other. By applying a laminate of multiple (alternating) getter layers 36a, 36b, 37a, 37b, the reliability of the blocking capacity of the energy source 33 for hindering active species (initially contained by the stack) to enter the substrate 34 can be improved. In this example the substrate 34 is not provided with any electronic component.

FIG. 5a shows a cross section of a fifth embodiment of an electrochemical energy source 44 according to the invention. The electrochemical energy source 44 comprises a silicon substrate 45 in which one or multiple electronic components 46 are embedded at least partially. On top of the substrate 45 successively an first electron-conductive lithium ion barrier layer 47, an oxide-based getter layer 48, a second electron-conductive lithium ion barrier layer 49, an anode 50, a solid-state electrolyte 51, a cathode 52, and a separate cathode current collector 53 are deposited. The second electron-conductive lithium ion barrier layer 49 also acts as an anode current collector in this illustrative example. The constructive structure of this energy source 44 resembles more or less to the constructive structure of the electrochemical energy source 10 as shown in FIG. 2. Free lithium which has diffused through the second barrier layer 49 will (normally) be captured by the oxide-based getter layer 48 according to the following reaction:

2Li+½SiO₂→Li₂O+½Si

This shows that lithium is present as Li₂O in the SiO₂ layer, so in its ionic form (Li⁺). Moreover, charged lithium which is not chemically bonded to oxygen will commonly also be present in the oxide-based getter layer 48. To prevent lithium ions (or ions of other active species) from entering the substrate, the first electron-conductive barrier layer 47, in this example formed by a tantalum layer, is deposited between the substrate 45 and the oxide-based getter layer 48. To realize an improved (lithium) ion barrier to prevent (lithium) ions to enter the substrate 45, an electric field is applied across the getter layer 48, which is shown more clearly in the detailed view of FIG. 5b. In particular the mobile charged lithium species, and more in particular mobile lithium ions, not being chemically bonded to oxygen, will commonly be ideally suitable to be subjected to an electric field to force a electromigration in a desired direction, as will be explained below.

FIG. 5b shows a detailed view of a part of the cross section of the energy source 44 as shown in FIG. 5a. More specifically, in FIG. 5b it is shown that an electrical field is applied across the getter layer 48 by applying a relatively high potential to the first barrier layer 47 and a relatively low potential to the second barrier layer 49. Subsequently, defects and vacancies will force the effective transport of Li⁺ through the SiO₂ layer back in the direction of the second barrier layer 49 under influence of the electrical field applied. The absolute potential of the second barrier layer 49 will commonly be equal to the potential of the anode (commonly ˜0.2-0.6 Volt vs. Li/Li+). The first barrier layer 47 is preferably connected to the cathode 52. This results in the fact that the first barrier layer 47 commonly has a potential of around 4 Volt in the case the cathode consists of LiCoO₂ (commonly used). The forced transport of lithium ions towards the second barrier layer 49 might result in the neutralization of lithium ions to lithium atoms, which atoms may relatively easily be incorporated in the second barrier layer 49. Aside from the fact that it is extremely facile to apply a potential difference across the first barrier layer 47 and the second barrier layer 49, this manner of blocking (lithium) ions based on electromigration is energetically also relatively efficient. Energy is merely dissipated if neutralization of ions to atoms occurs as described afore. As the total amount of ions in the oxide-based getter layer will commonly be extremely low merely an infinitesimal amount of energy is required.

It should be noted that the above-mentioned embodiments illustrate rather than limit the invention, and that those skilled in the art will be able to design many alternative embodiments without departing from the scope of the appended claims. In the claims, any reference signs placed between parentheses shall not be construed as limiting the claim. Use of the verb “comprise” and its conjugations does not exclude the presence of elements or steps other than those stated in a claim. The article “a” or “an” preceding an element does not exclude the presence of a plurality of such elements. The mere fact that certain measures are recited in mutually different dependent claims does not indicate that a combination of these measures cannot be used to advantage.

1. Electrochemical energy source, comprising:
a substrate;
at least one stack deposited onto said substrate, the stack including:
an anode,
a cathode,
an intermediate solid-state electrolyte separating said anode and said cathode, and
separate current collectors being electrically connected to the anode and the cathode, respectively; and
at least one electron-conductive barrier layer being deposited between the substrate and the anode, which barrier layer is adapted to at least substantially preclude diffusion of active species of the stack into said substrate, wherein the electrochemical energy source further comprises at least one getter layer being deposited between the substrate and the barrier layer for gettering active species which have been diffused through the barrier layer.

2. Electrochemical energy source according to claim 1, characterized in that at least one getter layer comprises at least one metal.

3. Electrochemical energy source according to claim 2, characterized in that at least one getter layer comprises at least one of the following metals: Sb, Bi, Sn, Ga, Cd, Pb, and In.

4. Electrochemical energy source according to claim 1, characterized in that at least one getter layer comprises at least one oxide.

5. Electrochemical energy source according to claim 4, characterized in that the oxide comprising getter layer comprises at least one of the following oxides: SiO2, GeO2, Al2O3, and Zr2O5.

6. Electrochemical energy source according to claim 1, characterized in that at least one electron-conductive layer is deposited between the substrate and the at least one getter layer.

7. Electrochemical energy source according to claim 6, characterized in that the electron-conductive layer comprises at least one of the following metals: Ta, Au, Ag, and Ti.

8. Electrochemical energy source according to claim 1, characterized in that at least one barrier layer is deposited between the substrate and the at least one getter layer, wherein the barrier layer is adapted to at least substantially preclude diffusion of active species of the stack into said substrate.

9. Electrochemical energy source according to claim 1, characterized in that the electrochemical energy source comprises a laminate of multiple getter layers being deposited between the substrate and the barrier layer.

10. Electrochemical energy source according to claim 1, characterized in that the electrochemical energy source comprises means for generating an electric field across at least one getter layer.

11. Electrochemical energy source according to claim 10, characterized in that the means for generating an electric field across the at least one getter layer is connected to two electron-conductive layers enclosing said getter layer.

12. Electrochemical energy source according to claim 10, characterized in that the at least one getter layer across which an electric field is generated comprises at least one oxide.

13. Electrochemical energy source according to claim 1, characterized in that the at least one barrier layer is made of at least one of the following materials: Ta, TaN, Ti, and TiN.

14. Electrochemical energy source according to claim 1, characterized in that at least one electrode is adapted for storage of ions of at least one of following elements: H, Li, Be, Mg, Cu, Ag, Na and K.

15. Electrochemical energy source according to claim 1, characterized in that the anode and/or the cathode is made of at least one of the following materials: C, Sn, Ge, Pb, Zn, Bi, Sb, and, Si.

16. (canceled)

17. Electrochemical energy source according to claim 1, characterized in that the substrate comprises Si.

18. Electronic assembly, comprising at least one electrochemical energy source according to claim 1, wherein at least one electronic component is at least partially embedded in the substrate of the electrochemical energy source.

19. Electronic assembly according to claim 18, characterized in that the substrate is provided with at least one integrated circuit (IC).

20. A method for manufacturing an electrochemical energy source according to, comprising the steps of:
A) depositing at least one electron-conductive barrier layer onto the substrate, and
B) depositing at least one stack of an anode, an solid-state electrolyte, a cathode and separate current collectors being electrically connected to the anode and the cathode, respectively, onto said electron-conductive barrier layer, wherein the method further comprises step C) comprising depositing at least one getter layer onto said substrate before step A) is carried out, wherein the electron-conductive barrier layer is deposited onto said getter layer.

21. Method according to claim 20, characterized in that during step C) a laminate of multiple getter layers is deposited onto the substrate.

22. Method according to claim 20, characterized in that the getter layer being deposited during step C) comprises at least one oxide.

23. Method according to claim 1, characterized in that the method further comprises step D) comprising the application of an electrical field across the getter layer deposited during step C).

24. Method according to claim 20, characterized in that the method further comprises step E) comprising depositing at least one metal layer onto said substrate before steps A)-D) are carried out.

25. Method according to one of claim 23, characterized in that an electrical potential is applied to both the electron-conductive barrier layer and the metal layer to generate an electrical field across the getter layer, wherein the lowest electrical potential is applied to the electron-conductive barrier layer.
